(19) United States
(12) Patent Application Publication
(10) Pub. No.: US 2026/0316179 A1
(43) Pub. Date: Oct. 15, 2026

(54) ADJUSTABLE FIXTURE ASSEMBLY FOR LASER MARKING OBJECTS

(71) Applicant: Samuel Palmeter, Caro, MI (US)

(72) Inventor: Samuel Palmeter, Caro, MI (US)

(73) Assignee: LMTGPR LLC, Caro, MI (US)

(21) Appl. No.: 19/177,517

(22) Filed: Apr. 12, 2025

(51) Int. Cl. B23K 26/02; B23K 26/352; B23K 37/04

(52) U.S. Cl. CPC B23K 26/02; B23K 26/352; B23K 37/0443

(57) ABSTRACT

An adjustable fixture assembly for marking objects, such as pistols, includes a base and an adjusting device. The base includes a platform having a first end, a second end, a pair of side walls, and a pair of tracks extending between the first end, and a second end. An activator section includes a neck section and a motor section including a motor having a circular base and a clamping surface for engaging the rear side of the pistol, wherein the clamping surface includes a first axis. A laser marking device marks the pistol, as the pistol is fixedly attached to the cradle.

### FIELD OF THE INVENTION

The present invention relates to laser marking, and more particularly, the present invention relates to an apparatus for laser marking of various substrates, such as weapons.

### DESCRIPTION OF THE BACKGROUND OF THE PRIOR ART

Laser marking methods have recently been developed for marking metals, plastics, ceramics and glasses. As known by those skilled in the art, the known methods of a laser marking of metals typically involves a vaporization process, wherein a laser is used to remove or ablate metal from the surface along the travel path of the laser. The resultant marking comprises engraved or indented portions which provide three-dimensional contrast to the surface of the metal.

There is another alternative process of laser marking of metals surfaces including annealing a selected portion of the metal surface to provide areas of contrasting color, wherein instead of removing metal from the surface, the laser is used to heat the surface of the metal to an annealing temperature which typically results in darkening of the annealed regions. Alluding to the above, plastics are typically laser marked by either changing the color of the plastic or engraving the surface of the plastic along the travel path of the laser. The color of the plastic is typically changed by localized melting and re-solidification of the plastic. In contrast, engraving is achieved by vaporization and removal of the plastic.

Various plastic laser engraving methods can be used to remove a surface layer of the plastic to reveal an underlying layer of contrasting color. In this prior art methods, two coating layers are applied to a glass substrate, and the top layer is removed by the laser to reveal the contrasting underlayer. Another prior art method teaches laser marking ceramics and glasses by using a glaze having a radiation-sensitive additive comprising an inorganic pigment or titanium dioxide is deposited and fired on the surface of a ceramic or glass substrate. A laser beam is then used to irradiate the fired surface layer to thereby change the color of the surface layer in the areas of irradiation.

Another prior art method teaches application of marking material to the surface of the substrate, followed by irradiation of a portion of the marking material to form a permanent marking on the substrate. The non-irradiated portion of the marking material is then removed from the substrate. The marking material may comprise glass frit or precursors thereof, inorganic pigments or precursors thereof, silicates, metal oxides, sulfides, nitrides and carbides, organometallic material or metal powders. The marking method is highly versatile, can be performed quickly, and produces permanent marks of high resolution and contrast without damage to the substrate.

Still another prior art reference teaches a method of laser marking metals, plastics, ceramic materials, glazes, glass ceramics, and glasses of any desired form, which comprises applying to the material to be marked a variable thickness layer of marking material containing energy absorbing enhancers then irradiating said layer with a laser or diode based energy source such that the radiation is directed onto said layer in accordance with the form of the marking to be applied, and using a laser or diode based energy source of a wavelength which is sufficiently absorbed by the marking material so as to create a bonding of the marking material to the surface of the workpiece at the irradiated areas.

Despite the above-noted marking techniques, a need still exists for a method of marking substrates such as metals, ceramics, glasses and plastics which is versatile and can be performed quickly, and which produces permanent marks of high resolution and contrast with minimal or no damage to the substrate.

There is also an opportunity for improved fixture device for fixedly holding various object such as weapons for marking the weapon while the weapon is fixedly attached to the fixture device without any movements during lase marking of the weapon.

The present invention aims to solve this problem by simple and convenient means.

### SUMMARY OF THE INVENTION

An adjustable fixture assembly for marking objects, such as pistols, includes a base and an adjusting device. The base includes a platform having a first end, a second end, a pair of side walls, and a pair of tracks extending between the first end, and a second end. An activator section extends from the first end. The activator section includes a neck section and a motor section including a motor having a circular base and a clamping surface for engaging the rear side of the pistol, wherein the clamping surface includes a first axis and three clamping elements movable to and away from the first axis to fixedly engage the butt side of the pistol.

The activator section includes a cradle member. The cradle includes a tongue section having side edges with a plurality of voids of various geometrical configurations and a pair of side arm sections connected to both side edges. The side edges extend to respective tip portions connected to the circular base wherein the cradle is rotatable about the first axis. A tower device is engaged with at least one of the tracks and is slidable movable along the tracks between the first end and the second end. The tower device includes a carriage having a channel defined in the bottom of the carriage to engage at least one of the tracks. A handle is connected to the carriage to move the tower device to and away from the activator section. A brake device is connected to the front end of the carriage to fixedly connect the carriage to at least one of the tracks when an extension element is attached to the carriage and extend therefrom vertically and then away from vertical orientation of terminating to a block defining an object engagement surface to be inserted into a muzzle end of the barrel of the pistol.

A weapon engaging section or a holding device for securing the pistol. The holding device includes a first part having at least one inclined surface. The first part includes a bottom surface to be connected to the tongue section. Several openings are defined in the inclined surface. A second part includes a rear inclined surface to be engaged with the inclined surface. The second part includes a top end defining a lip section with a female connector to mate with the opening and a central section with an inlet to mate with the opening.

A bracket section extends from the central section. The bracket section terminates to C-shape bracket defining an elongated opening. A pair of male connectors are used to connect the first part with the second part as the rear inclined surface is connected to the inclined surface.

An insert member is used to be inserted into an opening defined in the handle of the pistol. The insert member includes a plurality of openings. The insert member is inserted to or engaged with the C-shape bracket of the bracket section wherein the insert member is moved relative an axis and fixed by a second mail connector inserted through the elongated opening and any of the openings as the insert member is moved along the axis.

A laser marking device marks the pistol, as the pistol is fixedly attached to the cradle. As the cradle rotates about the axis, the laser marking device marks various surfaces of the pistol at various angles thereby allowing variety and flexibility in laser marking.

Another alternative embodiment of the present invention includes another design of an adjustable fixture assembly for marking objects, such as rifle(s), includes a base and an adjusting device. The base includes a platform having a first end, a second end, a pair of side walls, and a pair of tracks extending between the first end, and a second end. An activator section extends from the first end. The activator section includes a neck section and a motor section including a motor having a circular base and a clamping surface for engaging the rear side of the rifle, wherein the clamping surface includes a first axis and three clamping elements movable to and away from the first axis to fixedly engage the butt side of the rifle.

The activator section includes a cradle member. The cradle includes a tongue section having side edges with a plurality of voids of various geometrical configurations and a pair of side arm sections connected to both side edges. The side edges extend to respective tip portions connected to the circular base wherein the cradle is rotatable about the first axis. A tower device is engaged with at least one of the tracks and is slidable movable along the tracks between the first end and the second end. The tower device includes a carriage having a channel defined in the bottom of the carriage to engage at least one of the tracks. A handle is connected to the carriage to move the tower device to and away from the activator section. A brake device is connected to the front end of the carriage to fixedly connect the carriage to at least one of the tracks when an extension element is attached to the carriage and extend therefrom vertically and then away from vertical orientation of terminating to a block defining an object engagement surface to be inserted into a muzzle end of the barrel of the rifle.

A weapon engaging section includes a base block of a generally rectangular configuration connected to said tongue section, and a pair of weapon engaging elements presenting a first weapon engaging element adjustably connected to the base block and movable relative to the base block at in a first directional mode at various angles to and away from the activator section and positioned to be inserted into the rifle and a second weapon engaging element located within the first weapon engaging element and pivotable movable beyond the first weapon engaging element at a second directional mode different from the first directional mode to fixedly engage the void portion in the rifle and to prevent relative movement of the rifle in connection to the tongue section as the second weapon engaging element pivots about the first weapon engaging element.

A middle plate is connected to the base block. The first weapon engaging element is further defined by an insert plate connected to the middle plate. The insert plate includes a plurality of openings of various configurations. The insert plate is used to be inserted into a void portion in the rifle also knows as a magazine engaging area. The insert plate includes side walls and a slot defined inside the insert plate. The side walls include respective pockets defined therein to receive a pivoting element.

The second weapon engaging element is further defined by a tongue element including a front face, a rear face, and a peripheral side wall. An inlet whole extends through the peripheral side wall. A spring is inserted into the inside the pocket defined in the wall to engage the middle plate to allow springing effect between the middle plate and the tongue element. A pin is inserted into the pocket defined in the wall to fixedly engage the void portion in the rifle and to prevent relative movement of the rifle in connection to the tongue element as the tongue element pivots about the pivoting element extending beyond the insert plate. The insert plate is rotatable about the middle plate at various angles to move the insert plate and position the insert plate relative different rifles of various modifications.

A bracket includes a peripheral flange presenting a plurality of female connectors and a tubular portion extending from the peripheral flange. A pair of fixing pins are inserted through the connectors and further inserted into the whole defined in the middle plate to allow the bracket to be connected to the insert plate and rotate the insert plate about the middle plate.

A laser marking device marks the rifle, as the rifle is fixedly attached to the cradle. As the cradle rotates about the axis, the laser marking device marks various surfaces of the rifle at various angles thereby allowing variety and flexibility in laser marking.

A first fixture device includes a body defines a bottom extending to an open top and further defining an inner bottom portion. The body further defines a slot having side walls. The opening defined by the body is used to mechanically receive a part of the rifle in male and female engagement when the rifle is fixedly attached and secured between the object engagement surface and the clamping surface. The bottom includes a neck portion having a hexagonal cross section to be inserted between and fixedly engaged by the clamping devices.

A second fixture device includes a body and a top surface and a bottom surface. The body has a first end and a second end. The second end presents a semicircular shape and extends to the first end connected by inclined walls. A first male connector and a second male connector present a generally circular cross section and are adjacent one another. The first and second fixture devices are formed from polymeric and non-polymeric materials without limiting the scope of the present invention.

The first and second fixture devices are used to engage the rear portion of the rifle R that is hollow or semi-hollow in order to rigidly engage the rifle R in male and female engagement.

Advantage of the present invention is to provide an inventive fixture device for fixedly holding various object such as weapons for marking the weapon while the weapon is fixedly attached to the fixture device without any movements during laser marking of the weapon.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of an adjustable fixture assembly for marking objects, such as a pistol;

FIG. 2 illustrates a side view of the adjustable fixture assembly for marking the pistol, shown in phantom;

FIG. 3 illustrates a fragmental and exploded view of a holding device for securing the pistol; and

FIG. 4 illustrates another side view of the adjustable fixture assembly for marking the pistol.

FIG. 5 illustrates a perspective view of a first alternative design of an adjustable fixture assembly for marking objects, such as a rifle;

FIG. 6 illustrates another perspective view of the adjustable fixture assembly for marking objects, wherein an object, such as a weapon, is shown in phantom;

FIG. 7 illustrates a side view of the adjustable fixture assembly for marking objects;

FIG. 8 illustrates a top view of the adjustable fixture assembly for marking objects;

FIG. 9 illustrates a fragmental view of an adjusting device of the adjustable fixture assembly, wherein the adjusting device is located inside the weapon for fixedly attaching the weapon to the adjusting device while the weapon being marked by a laser marking device;

FIG. 10 illustrates a fragmental and exploded view of the adjusting device of the adjustable fixture assembly;

FIG. 11 illustrates a cross sectional view the adjustable fixture assembly of FIG. 5;

FIG. 12 illustrates a perspective view of a second alternative design of an adjustable fixture assembly for marking objects, such as a rifle, shown in phantom;

FIG. 13 illustrates a perspective view of the second alternative design of the adjustable fixture assembly;

FIG. 14 illustrates a fragmental and perspective view of a first end of the second alternative design of the adjustable fixture assembly rifle showing a first fixture device for holding a real part of the rifle;

FIG. 15 shows a perspective view of the first fixture device taken from front;

FIG. 16 shows a rear view of the first fixture device;

FIG. 17 shows a front view of the first fixture device;

FIGS. 18 through 20 show several alternative embodiments of the rear side of the first fixture device;

FIG. 21 illustrates a perspective view of a third alternative design of an adjustable fixture assembly for marking objects, such as a rifle, shown in phantom;

FIG. 22 illustrates a perspective view of the second alternative design of the adjustable fixture assembly;

FIG. 23 illustrates a fragmental and perspective view of a first end of the third alternative design of the adjustable fixture assembly rifle showing a first fixture device for holding a real part of the rifle;

FIG. 24 shows a perspective view of the second fixture device taken from front;

FIG. 25 shows a rear view of the second fixture device;

FIG. 26 shows a front view of the second fixture device;

FIGS. 27 through 29 show several alternative embodiments of the rear side of the second fixture device; and

FIG. 30 shows a side view of the second fixture device.

### DETAILED DESCRIPTION OF THE INVENTION

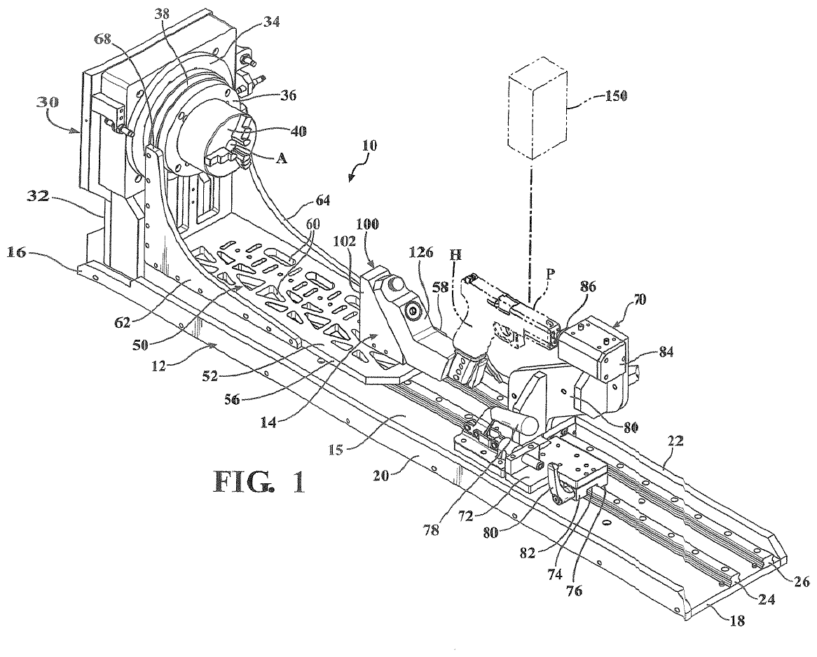

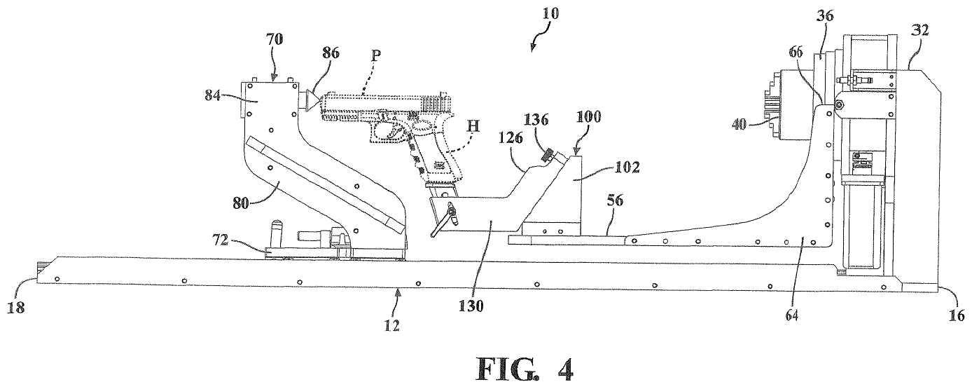

Referring to the FIGS. 1 through 4, an adjustable fixture assembly for marking objects, such as pistols, with laser, is generally shown at 10. Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments.

These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The adjustable fixture assembly 10 for marking objects, such as pistol(s) P, shown in phantom, and pistols (not shown) includes a base, generally indicated at 12 and an adjusting device, generally indicated at 14. The base 12 includes a platform 15 having a first end 16, a second end 18, a pair of side walls 20, 22, and a pair of tracks 24, 26 extending between the first end 16, and a second end 18. The base 12 is placed on a surface, such as a worktable (not shown) or can be a part of another installation (not shown).

An activator section, generally indicated at 30, extends from the first end 16. The activator section 30 includes a neck section 32 and a motor section 34 including a motor 36 having a circular base 38 and a clamping surface 40. The clamping surface 40 includes a first axis A.

The activator section 30 includes a cradle member, generally indicated at 50. The cradle 50 includes a tongue section 52 having side edges 56, 58 with a plurality of voids of various geometrical configurations (only one is shown at 60) and a pair of side arm sections 62, 64 connected to both side edges 56, 58. The side edges 56, 58 extend to respective tip portions 66, 68 connected to the circular base 38 wherein the cradle 50 is rotatable about the first axis A. All components such as the base 12, the activator section 30, the cradle 50 are formed from polymeric and non-polymeric materials without limiting the scope of the present invention.

Alluding to the above, a tower device, generally indicated at 70, is engaged with at least one of the tracks 24, 26 and is slidable movable along the tracks 24, 26 between the first end 16 and the second end 18. The tower device 70 includes a carriage 72 having a channel 74 defined in the bottom 76 of the carriage 72 to engage at least one of the tracks 24, 26. A handle 78 is connected to the carriage 72 to move the tower device 70 to and away from the activator section 30.

A brake device 80 is connected to the front end 82 of the carriage 72 to fixedly connect the carriage 72 to at least one of the tracks 24, 26 when an extension element 80 is attached to the carriage 72 and extend therefrom vertically and then away from vertical orientation of terminating to a block 84 defining an object engagement surface 86 to be inserted into a muzzle end of the barrel of the pistol R. The tower device 70 is formed from polymeric and non-polymeric materials without limiting the scope of the present invention.

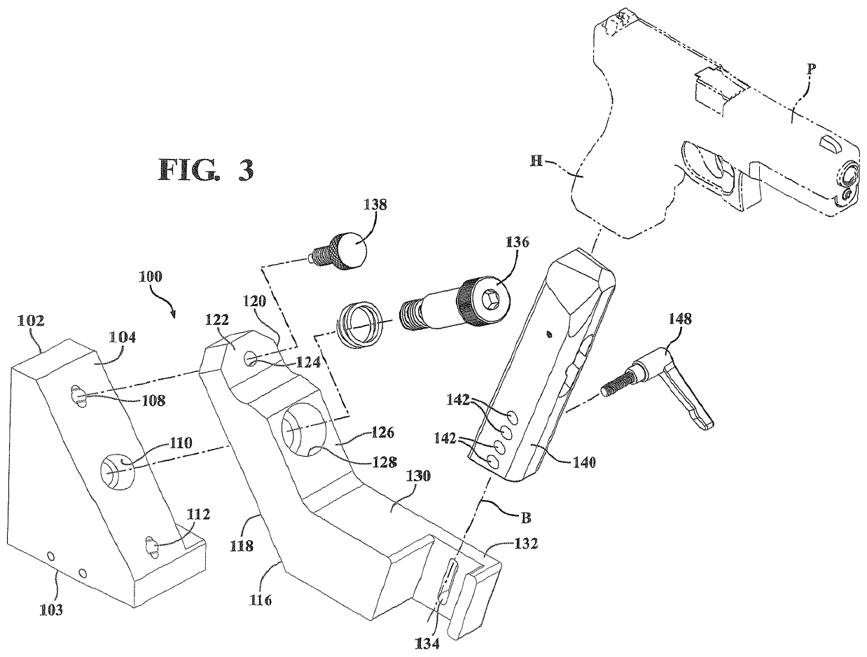

As best shown in FIG. 3, the assembly 10 includes a weapon engaging section or a holding device for securing the pistol P, generally indicated at 100. The holding device 100 includes a first part 102 having at least one inclined surface 104. The first part 102 includes a bottom surface to be connected to the tongue section 52. Several openings 108, 110, and 112 are defined in the inclined surface 104. A second part 116 includes a rear inclined surface 118 to be engaged with the inclined surface 104. The second part 116 includes a top end 120 defining a lip section 122 with a female connector 124 to mate with the opening 108 and a central section 126 with an inlet 128 to mate with the opening 110.

A bracket section 130 extends from the central section 126. The bracket section 130 terminates to C-shape bracket 132 defining an elongated opening 134. A pair of male connectors 136 and 138 are used to connect the first part 102 with the second part 116 as the rear inclined surface 118 is connected to the inclined surface 104. The second part 116 may change orientation based on required/desired position of the pistol P to be laser marked. The second part 116 is rotated about the male connector 136 wherein the lip section 122 with the female connector 124 will mate with the opening 112 defined in the inclined surface 104 wherein the C-shape bracket 132 will be positioned above the first part 102

An insert member 140 is used to be inserted into an opening defined in the handle H of the pistol P. The insert member 140 includes a plurality of openings 142. The insert member 140 is inserted to or engaged with the C-shape bracket 132 of the bracket section 130 wherein the insert member 140 is moved relative an axis B and fixed by a second mail connector 148 inserted through the elongated opening 134 and any of the openings 142 as the insert member 140 is moved along the axis B.

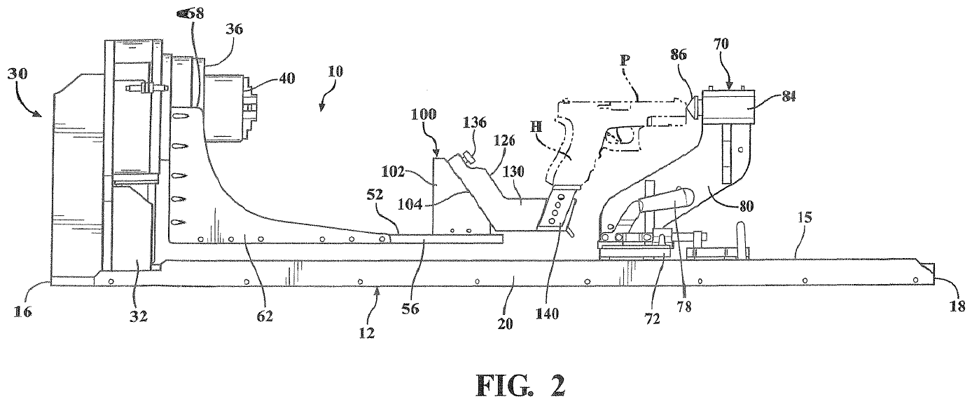

A laser marking device, as shown in phantom at 150, marks the pistol R, as the pistol P is fixedly attached to the cradle 50, as best shown in FIG. 2. The assembly 10, can be activated remotely. As the cradle 50 rotates about the axis, the laser marking device 150 marks various surfaces of the pistol R at various angles thereby allowing variety and flexibility in laser marking.

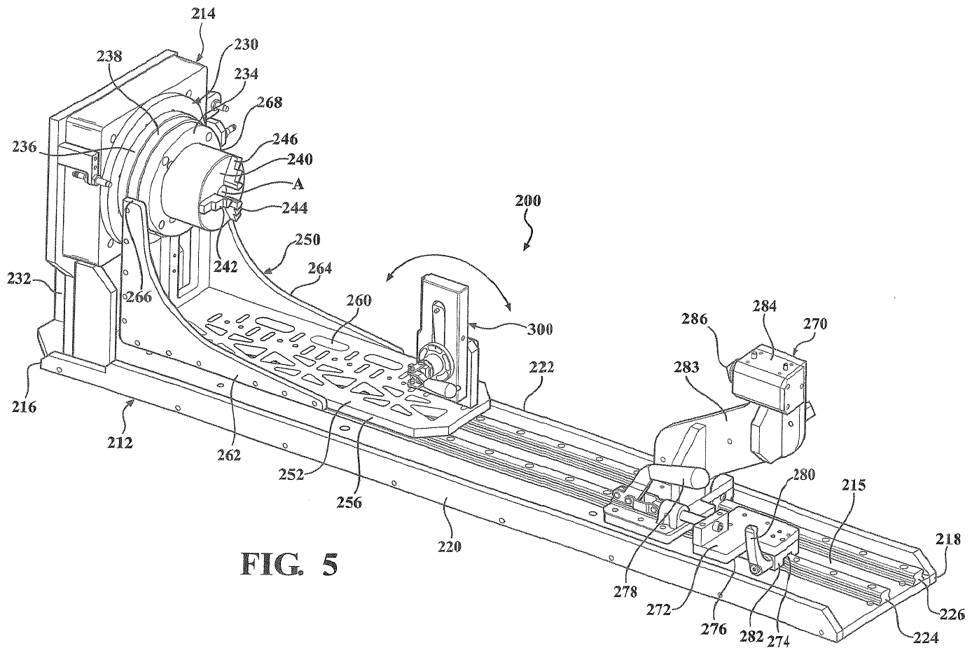

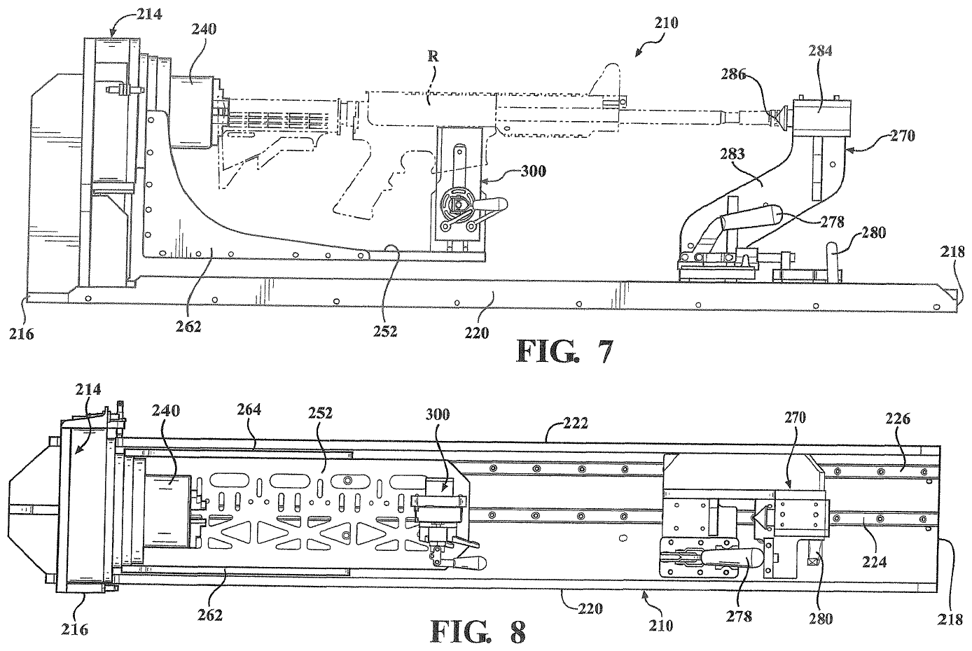

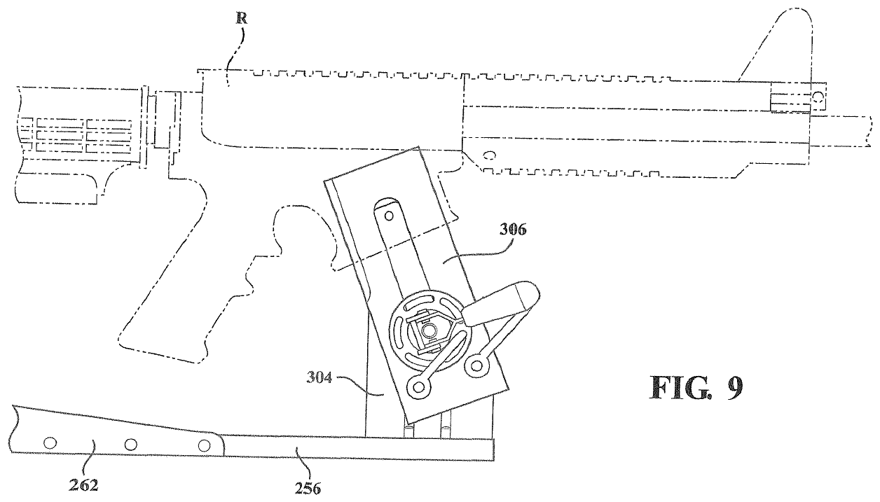

Referring to the FIGS. 5 through 11, a first alternative design of the adjustable fixture assembly, generally shown at 200, used for marking objects, such as rifle(s) R, shown in phantom, includes a base, generally indicated at 212 and an adjusting device, generally indicated at 214. The base 212 includes a platform 215 having a first end 216, a second end 218, a pair of side walls 220, 222, and a pair of tracks 224, 226 extending between the first end 216, and a second end 218. The base 212 is placed on a surface, such as a worktable (not shown) or can be a part of another installation (not shown).

An activator section, generally indicated at 230, extends from the first end 216. The activator section 230 includes a neck section 232 and a motor section 234 including a motor 236 having a circular base 238 and a clamping surface 240 for engaging the rear side of the rifle R, wherein clamping surface 240 includes a first axis A and three clamping elements 242, 244, and 246 movable to and away from the first axis A to fixedly engage the butt side of the rifle R.

The activator section 230 includes a cradle member, generally indicated at 250. The cradle 250 includes a tongue section 252 having side edges 256, 258 with a plurality of voids of various geometrical configurations (only one is shown at 260) and a pair of side arm sections 262, 264 connected to both side edges 256, 258. The side edges 256, 258 extend to respective tip portions 266, 268 connected to the circular base 238 wherein the cradle 250 is rotatable about the first axis A. All components such as the base 212, the activator section 230, the cradle 250 are formed from polymeric and non-polymeric materials without limiting the scope of the present invention.

Alluding to the above, a tower device, generally indicated at 270, is engaged with at least one of the tracks 224, 226 and is slidable movable along the tracks 224, 226 between the first end 216 and the second end 218. The tower device 270 includes a carriage 272 having a channel 274 defined in the bottom 276 of the carriage 272 to engage at least one of the tracks 224, 226. A handle 278 is connected to the carriage 272 to move the tower device 270 to and away from the activator section 230.

A brake device 280 is connected to the front end 282 of the carriage 272 to fixedly connect the carriage 272 to at least one of the tracks 224, 226 when an extension element 283 is attached to the carriage 272 and extend therefrom vertically and then away from vertical orientation of terminating to a block 284 defining an object engagement surface 286 to be inserted into a muzzle end of the barrel of the rifle R. The tower device 270 is formed from polymeric and non-polymeric materials without limiting the scope of the present invention.

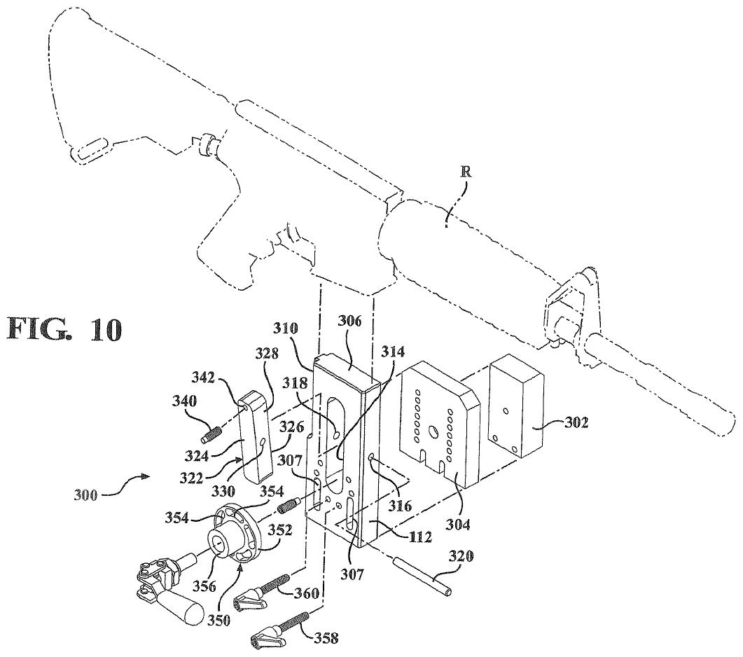

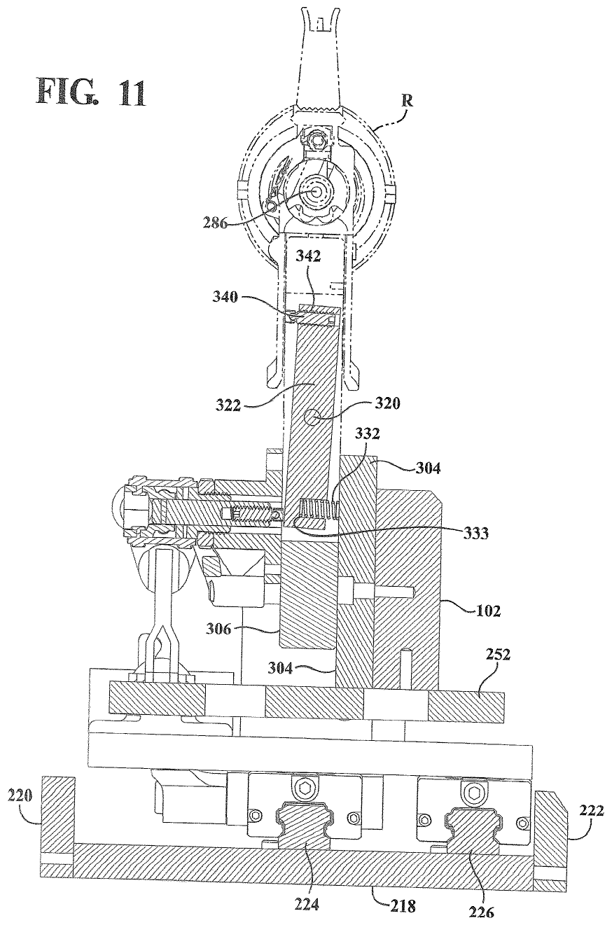

As best shown in FIGS. 10 and 11, the assembly 200 includes a weapon engaging section or device, generally indicated at 300. The section 300 includes a base block 302 of a generally rectangular configuration. The base block 302 is connected to the tongue section 252. A middle plate 304 is connected to the base block 302. An insert plate 306 is connected to the middle plate 304. The insert plate 306 presents a generally rectangular configuration without limiting the scope of the present invention. The insert plate 306 includes a plurality of openings 307 of various configurations. The insert plate 306 is used to be inserted into a void portion in the rifle R also knows as a magazine engaging area as shown in FIGS. 10 and 11.

Alluding to the above, the insert plate 306 includes side walls 310 and 312 and a slot 314 defined inside the insert plate 306. The side walls 310 and 312 include respective pockets 316, 318 defined therein to receive a pivoting element 320. A tongue element 322 includes a front face 324, a rear face 326 and a peripheral side wall 328. An inlet whole 330 extends through the peripheral side wall 328.

Alluding to the above, a spring 332 is inserted into the inside spring pocket 333 defined in the tongue element 332 to engage the middle plate 304 to allow springing effect between the middle plate 304 and the tongue element 322. A pin 340 is inserted into a pocket 342 defined in the wall 324 to fixedly engage the void portion in the rifle R and to prevent relative movement of the rifle R in connection to the tongue element 322 as the tongue element 322 pivots about the pivoting element 320 extending beyond the insert plate 306.

Alluding to the above, the insert plate 306 is rotatable about the middle plate 304 at various angles to move the insert plate 306 and position the insert plate relative different rifles R of various modifications. A bracket, generally indicated at 350, includes a peripheral flange 352 presenting a plurality of female connectors 354 and a tubular portion 356 extending from the peripheral flange 352. A pair of fixing pins 358, 360 are inserted through the connectors 354 and further inserted into the whole defined in the middle plate 304 to allow the bracket 350 to be connected to the insert plate 306 and rotate the insert plate 306 about the middle plate 304.

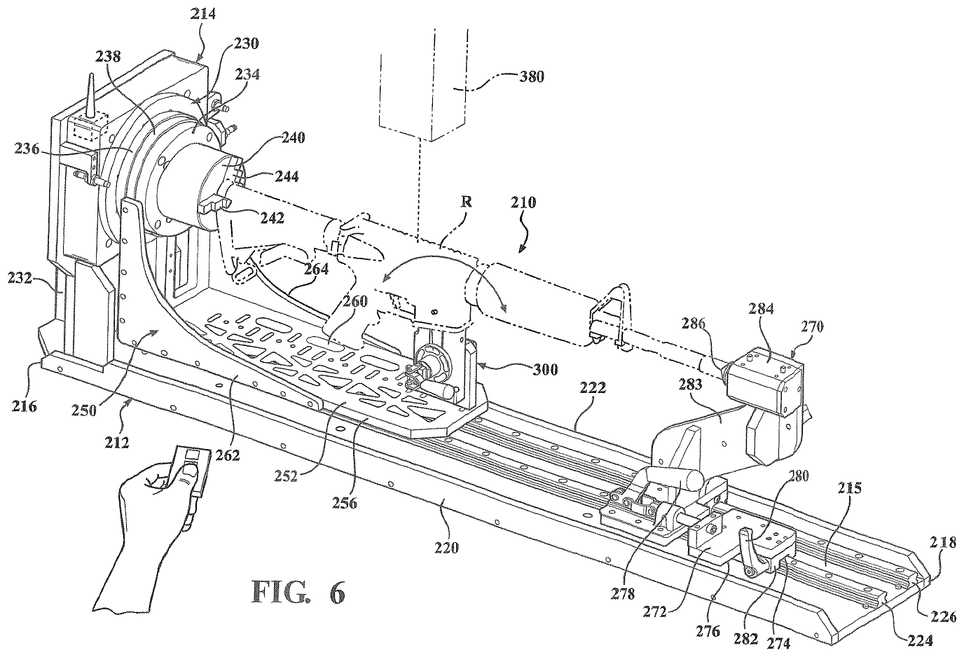

A laser marking device, as shown in phantom at 380, marks the rifle R, as the rifle R is fixedly attached to the cradle 250, as best shown in FIG. 6. The assembly 200, can be activated remotely. As the cradle 250 rotates about the axis, the laser marking device 380 marks various surfaces of the rifle R at various angles thereby allowing variety and flexibility in laser marking.

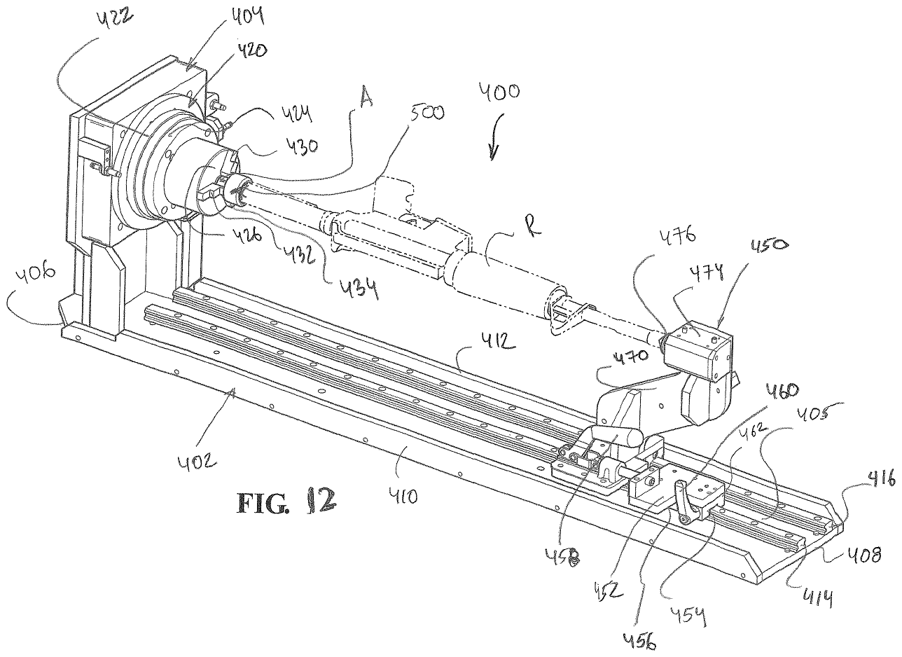

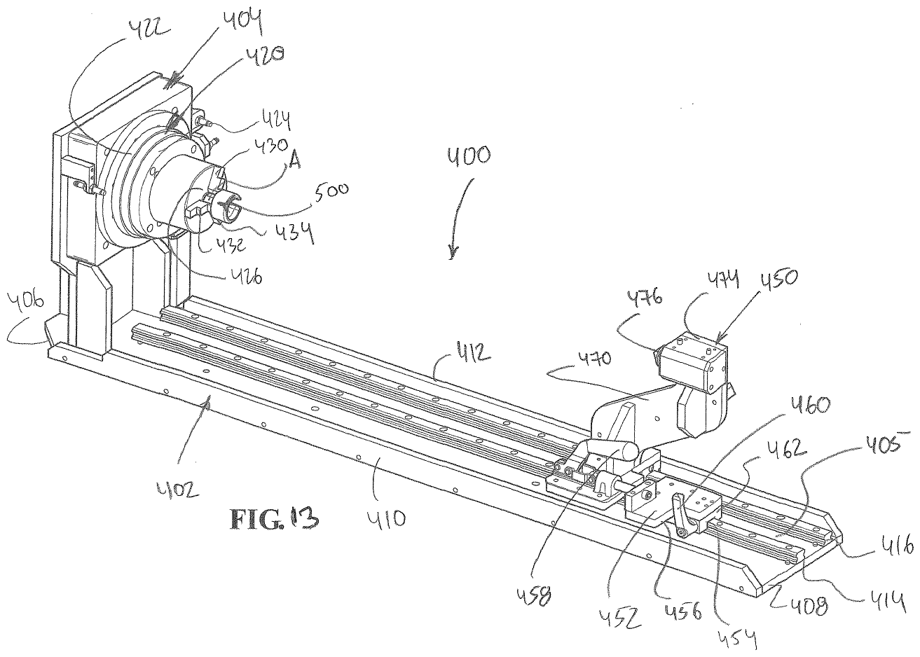

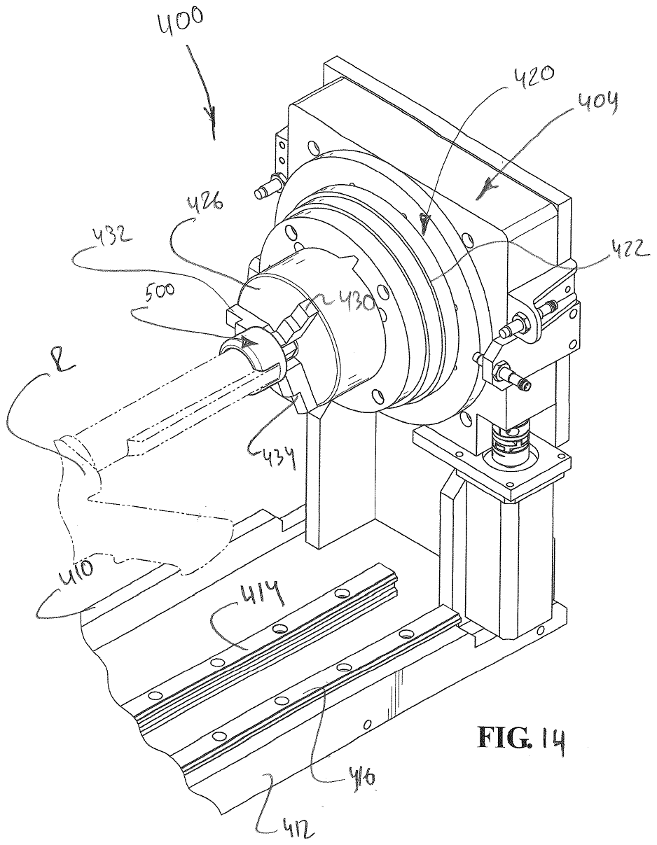

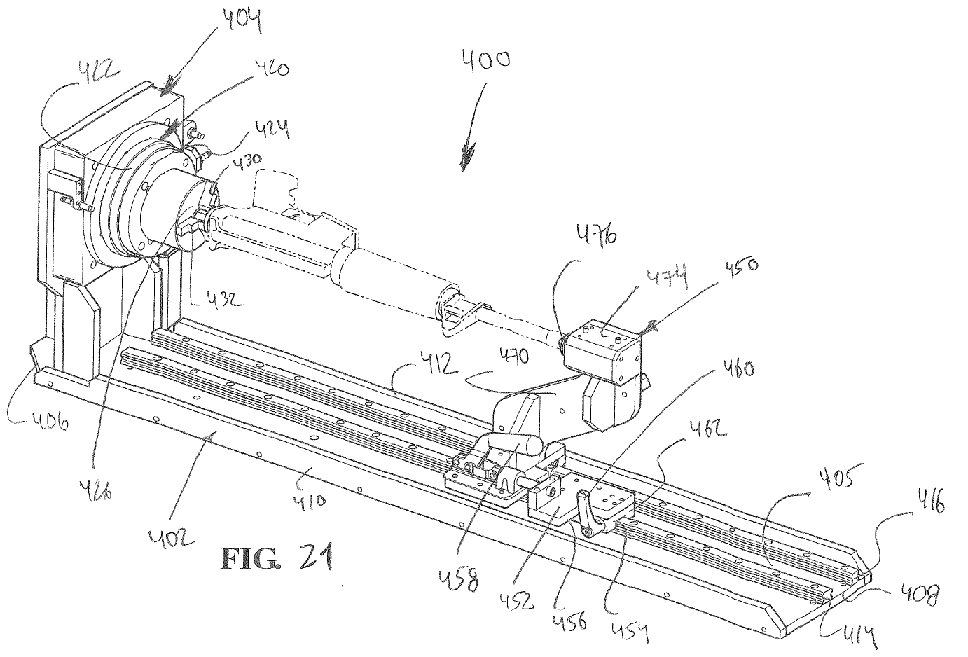

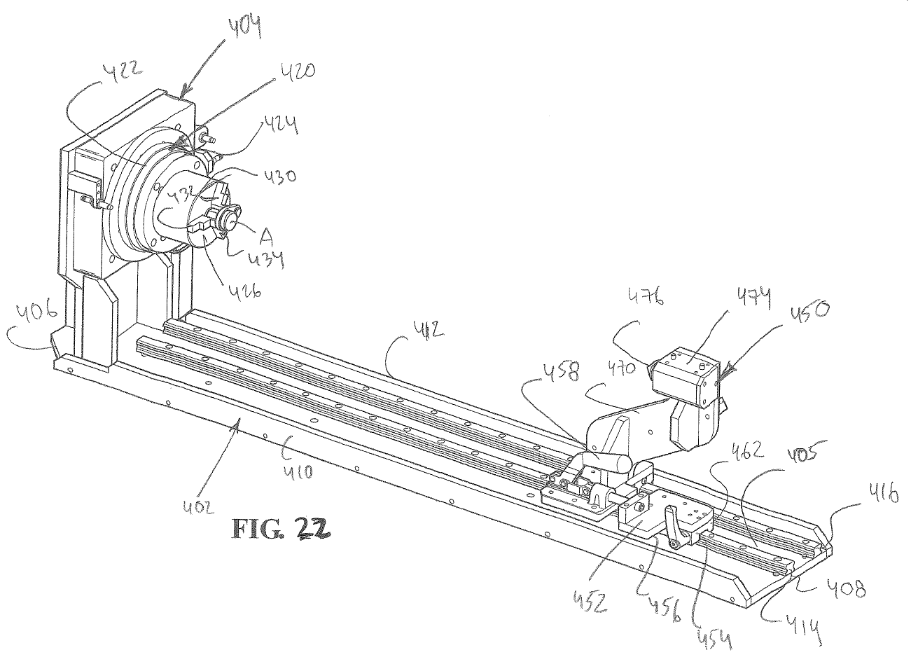

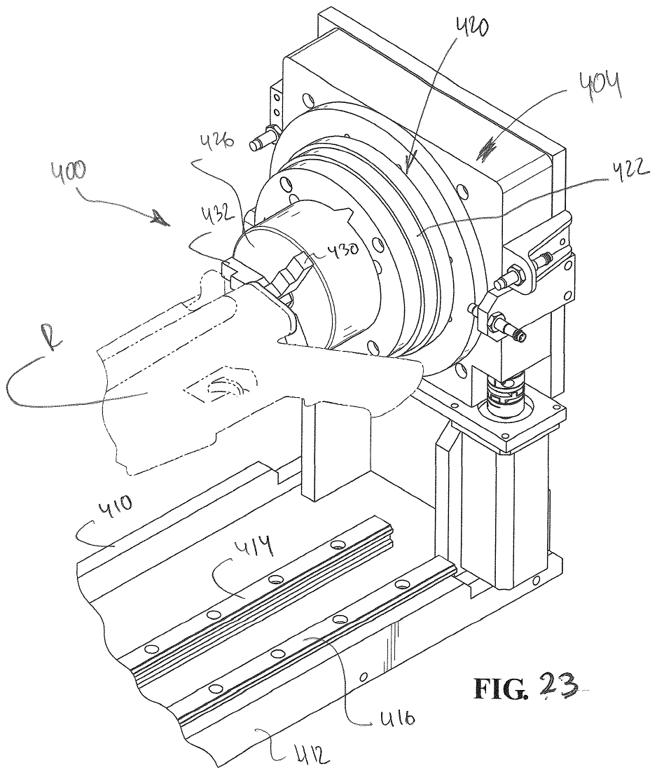

FIGS. 12-14 and 22-23, illustrate various perspective views of a second alternative design of an adjustable fixture assembly for marking objects, such as a rifle, generally indicated at 400. The adjustable fixture assembly 400 for marking objects, such as rifle (R), shown in phantom, includes a base, generally indicated at 402 and an adjusting device, generally indicated at 404. The base 402 includes a platform 405 having a first end 406, a second end 408, a pair of side walls 410, 412, and a pair of tracks 414, 416 extending between the first end 406, and the second end 408. The base 402 is placed on a surface, such as a worktable (not shown) or can be a part of another installation (not shown).

An activator section, generally indicated at 420, extends from the first end 406. The activator section 420 includes a motor section 422 including a motor having a circular base 424 and a clamping surface 426. At least three clamping devices 430, 432, and 434 are movable to and away from a central axis A to hold the rear part of the rifle R. All components such as the base 402, the activator section 420 are formed from polymeric and non-polymeric materials without limiting the scope of the present invention.

Alluding to the above, a tower device, generally indicated at 450, is engaged with at least one of the tracks 414, 416 and is slidable movable along the tracks 414, 416 between the first end 406 and the second end 408. The tower device 450 includes a carriage 452 having a channel 454 defined in the bottom 456 of the carriage 452 to engage at least one of the tracks 414, 416. A handle 458 is connected to the carriage 452 to move the tower device 450 to and away from the activator section 420.

A brake device 460 is connected to the front end 462 of the carriage 452 to fixedly connect the carriage 452 to at least one of the tracks 414, 416 when an extension element 470 is attached to the carriage 452 and extend therefrom vertically and then away from vertical orientation of terminating to a block 474 defining an object engagement surface 476 to be inserted into a muzzle end of the barrel of the rifle R. The tower device 450 is formed from polymeric and non-polymeric materials without limiting the scope of the present invention.

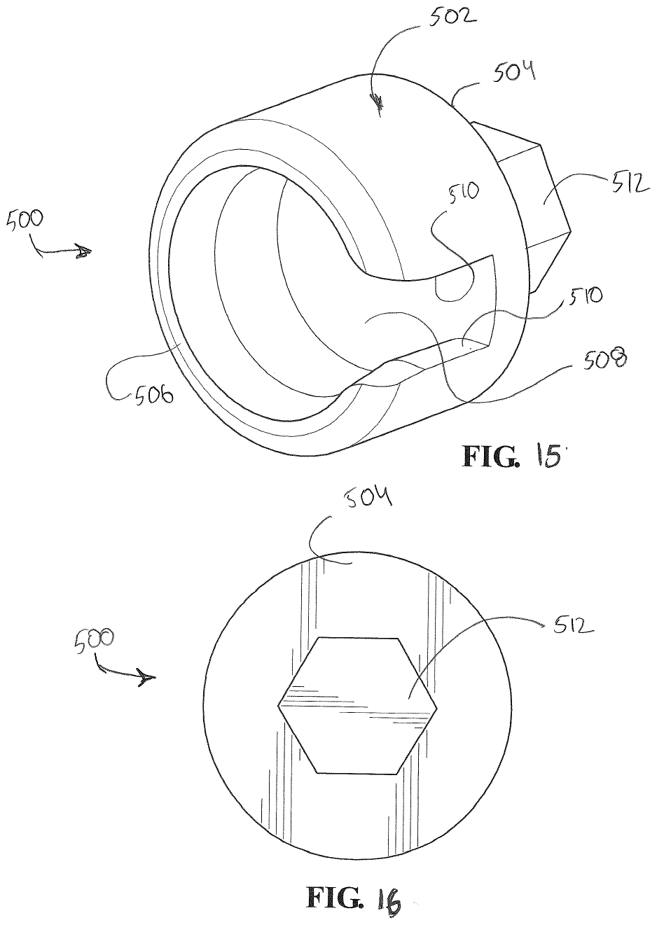

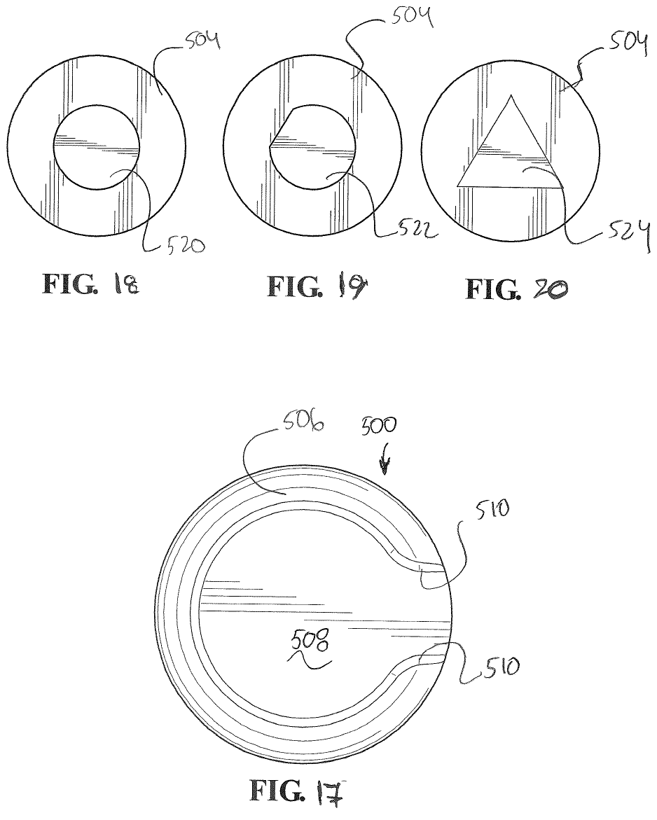

Referring to FIGS. 15 through 20, a first fixture device, generally shown at 500, includes a body, generally indicated at 502, defining a bottom 504. The body 502 extends to an open top 506 and further defining an inner bottom portion 508. The body 502 further defines a slot having side walls 510. The opening defined by the body 502 is used to mechanically receive a part of the rifle R in male and female engagement when the rifle R is fixedly attached and secured between the object engagement surface 476 and the clamping surface 426. The bottom 504 includes a neck portion 512 having a hexagonal cross section to be inserted between and fixedly engaged by the clamping devices 430, 432, and 434.

FIGS. 18 through 20 present various cross sections of the neck portion, such as a circular cross section, as shown at 520, a semi-circular cross section, shown at 522, and a triangular cross section, shown at 524. The cross-sections shown in FIGS. 18-20 are not intended to limit the scope of the present invention. The first fixture device 500 is formed from polymeric and non-polymeric materials without limiting the scope of the present invention. The first fixture device 500 is used to engage the rear portion of the rifle R that is flat in order to rigidly engage the rifle R in male and female engagement.

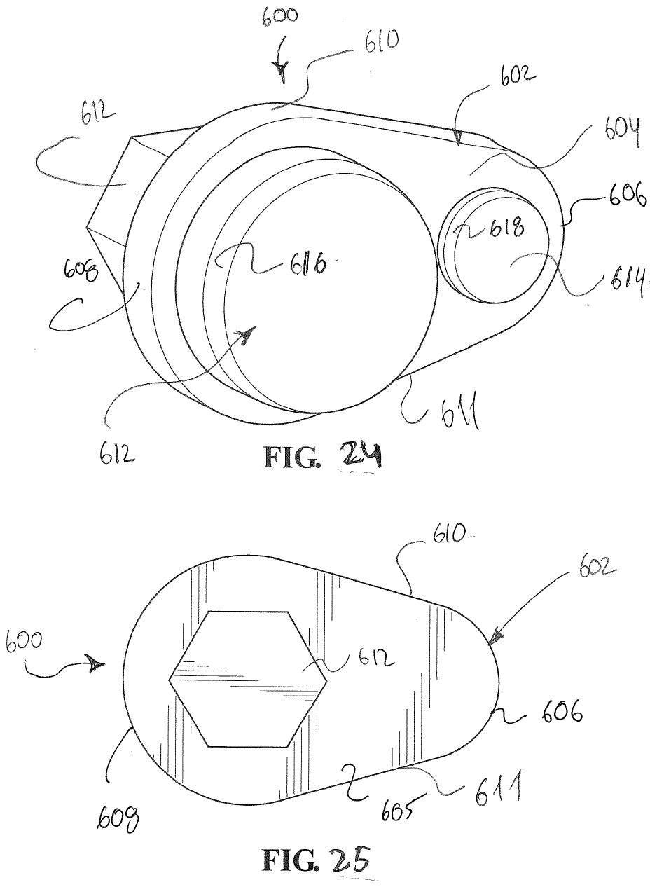

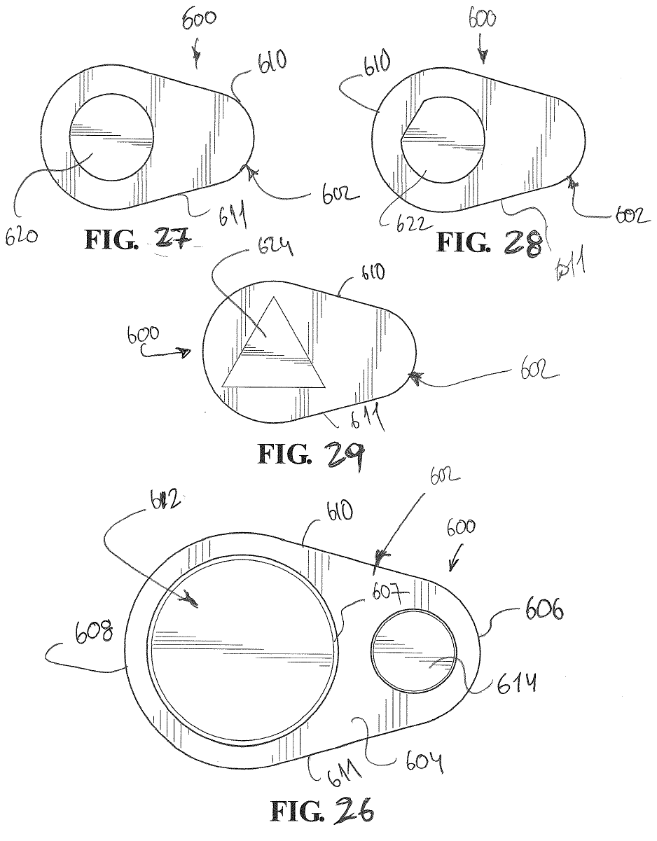

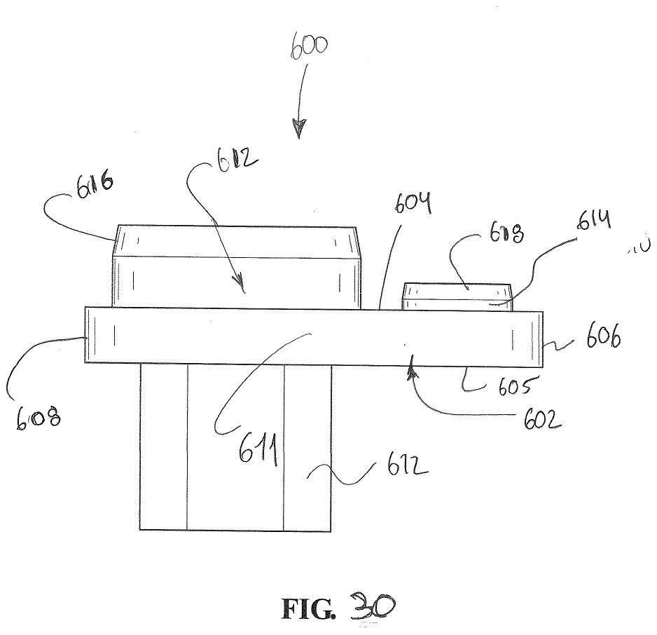

Referring to FIGS. 24 through 30, a second fixture device, is generally shown at 600. The second fixture device 600 includes a body, generally indicated at 602, and a top surface 604 and a bottom surface 605. The body 602 has a first end 606 and a second end 608. The second end 608 presents a semicircular shape and extends to the first end 606 connected by inclined walls 610 and 611.

A first male connector, generally indicated at 612, is adjacent the second end 608. The first male connector 612 present a generally circular cross section, and a circular inclined end wall 616. The second male connector 614 present a generally circular cross section, and a circular inclined end wall 618. The first male connector 612 and the second male connector 614 are adjacent one another.

The bottom surface 605 includes a neck portion 612 has a hexagonal cross section to be inserted between and fixedly engaged by the clamping devices 430, 432, and 434. FIGS. 27 through 29 present various cross sections of the neck portion, such as a circular cross section, as shown at 620, a semi-circular cross section, shown at 622, and a triangular cross section, shown at 624. The cross-sections shown in FIGS. 27-29 are not intended to limit the scope of the present invention. The second fixture device 600 is formed from polymeric and non-polymeric materials without limiting the scope of the present invention. The second fixture device 600 is used to engage the rear portion of the rifle R that is hollow or semi-hollow in order to rigidly engage the rifle R in male and female engagement.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best mode contemplated for carrying out this invention, but that the invention will include all embodiments falling within the scope of the appended claims.

1. An adjustable fixture assembly for marking an object with laser, said adjustable fixture assembly comprising:
a base including a platform having a first end, a second end, a pair of side walls;
a clamping surface and an object engaging surface sharing an axis, and engaging the object therebetween; and
at least one fixture device inserted into said clamping surface, said at least one fixture device configured to at least receive part of the object and extend to the part of said object to mechanically engage the object with said clamping surface as the object is fixedly attached and secured between said object engagement surface and said clamping surface to be marked by a laser.

2. The adjustable fixture assembly as set forth in claim 1, wherein said at least one fixture device is further defined by a first fixture device including a body.

3. The adjustable fixture assembly as set forth in claim 2, wherein said body further defines a bottom part extending to an open top and further defining an inner bottom portion.

4. The adjustable fixture assembly as set forth in claim 3, wherein said body further defines a slot having side walls.

5. The adjustable fixture assembly as set forth in claim 2, wherein said bottom part includes a neck portion.

6. The adjustable fixture assembly as set forth in claim 5, wherein said neck portion presents a hexagonal cross section to be inserted between and fixedly engaged by clamping devices of said clamping surface.

7. The adjustable fixture assembly as set forth in claim 1, wherein said at least one fixture device is further defined by a second fixture device including a body and a top surface and a bottom surface, said body presenting a first end and a second end.

8. The adjustable fixture assembly as set forth in claim 7, wherein said second end presents a semicircular shape and extends to said first end connected by inclined walls

9. The adjustable fixture assembly as set forth in claim 8, including a first male connector of said second fixture device presenting a generally circular cross section and a circular inclined end wall.

10. The adjustable fixture assembly as set forth in claim 9, including a second male connector of said second fixture device presenting a generally circular cross section and a circular inclined end wall.

11. The adjustable fixture assembly as set forth in claim 10, including a bottom surface of said second fixture device having a neck portion with a hexagonal cross section to be inserted between and fixedly engaged by said clamping devices.

12. The adjustable fixture assembly as set forth in claim 1, including an activator section with a neck section and a motor section including a motor.

13. The adjustable fixture assembly as set forth in claim 1, wherein said base includes a pair of tracks extending between said first end, said a second end.

14. The adjustable fixture assembly as set forth in claim 6, wherein said clamping devices are movable to and away from the axis to fixedly engage the part of the object.

15. The adjustable fixture assembly as set forth in claim 13, including a tower device is engaged with at least one of said tracks and is slidable movable along said tracks between said first end and said second end, said tower device including a carriage having a channel defined in the bottom of the carriage to engage at least one of the tracks.

16. The adjustable fixture assembly as set forth in claim 15, including a brake device connected to said front end of said carriage to fixedly connect said carriage to at least one of said tracks when an extension element is attached to said carriage and extend therefrom vertically and then away from vertical orientation terminating to a block defining said object engagement surface to be inserted into the object.

17. The adjustable fixture assembly as set forth in claim 1, wherein the object is a rifle.

18. An adjustable fixture assembly for marking an object with laser, said adjustable fixture assembly comprising:
a base including a platform having a first end, a second end, a pair of side walls;
a clamping surface and an object engaging surface sharing an axis, and engaging the object therebetween;
at least one of a first fixture device and a second fixture device inserted into said clamping surface, said at least one fixture device configured to at least receive part of the object and extend to the part of said object to mechanically engage the object with said clamping surface as the object is fixedly attached and secured between said object engagement surface and said clamping surface to be marked by a laser;
said first fixture device including a body defining a bottom part extending to an open top and further defining an inner bottom portion, wherein said body further defines a slot having side walls, said bottom part includes a neck portion presenting a hexagonal cross section to be inserted between and fixedly engaged by clamping devices of said clamping surface;
said second fixture device including a body and a top surface and a bottom surface, said body presenting a first end and a second end, wherein said second end presents a semicircular shape and extends to said first end connected by inclined walls; and
a first male connector of said second fixture device presenting a generally circular cross section and a circular inclined end wall, a second male connector of said second fixture device presenting a generally circular cross section and a circular inclined end wall, a bottom surface of said second fixture device having a neck portion with a hexagonal cross section to be inserted between and fixedly engaged by said clamping devices.
